(19) United States
(12) Patent Application Publication
(10) Pub. No.: US 2013/0138023 A1
(43) Pub. Date: May 30, 2013

(54) DEVICE FOR MASSAGING OR TREATING THE MUSCLES OF THE BACK AND NECK

(71) Applicant: Alfredo Lerro, Wollerau (CH)

(72) Inventor: Alfredo Lerro, Wollerau (CH)

(73) Assignee: ATLANTOTEC, Wollerau (CH)

(21) Appl. No.: 13/636,273

(22) PCT Filed: Mar. 22, 2011
(86) PCT No.: PCT/EP2011/054300

§ 371 Date: Nov. 29, 2012

(30) Foreign Application Priority Data
Mar. 22, 2010 (CH) 00422/10
Jul. 20, 2010 (CH) 01187/10

(51) Int. Cl. A61H 1/00

(52) U.S. Cl. CPC A61H 1/005
USPC 601/46

(57) ABSTRACT

The invention relates to a device (1) for massaging or treating the muscles of the back and neck of a patient, comprising a housing (2) in which a drive motor (3) drives an annular crank track (6) by means of a gearbox (4). A lift motion acting on a massage finger (8) is generated by means of a guide unit (7). The geometric dimensions of the annular crank track determine the constant amplitude or the constant stroke of the massage finger (8) or of the massage head (83) thereof. The massage finger (8) is thus displaced at a constant amplitude, while the frequency is changed in accordance with a controller (10). The massage device (1) according to the invention works extremely quietly. The special construction thereof allows the resonant frequency of each muscle to be achieved.

The present invention relates to a device for massaging or treatment of the back and neck muscles of a patient, comprising a housing having a drive motor disposed therein, which indirectly generates an adjustable lift motion with a constant amplitude in the axial direction on a massaging finger, comprising a massaging body and a fixing pin for connection of the finger with a drive of the spine massage device.

Massages of this kind are carried out by physical therapists, and especially by atlas therapists. When the spine is straight, the weight is evenly distributed between the two halves of the body. The head rests with its weight of 5 to 6 kg on the atlas. The shifted atlas forms an inclined supporting surface for the head so that it is no longer perpendicular to the cervical spine. Given this situation, the center of mass of the body shifts and the result is a muscle imbalance. There arises a faulty static posture. Thus, neck pain, tension headaches, dizziness, and limitations in the head rotation occur. If a deviation from the correct attitude occurs, there develops permanent muscular tension, which can cause pain and subluxation of the vertebrae. A positional correction of the atlas can be realized only if the problem of the permanent muscle tension is resolved. The physical therapist tries to relax a muscle tension by putting pulsing pressure with his two middle fingers on both sides of the spine.

The massage of the spine is applied by a physiotherapist or atlas therapist selectively and extensively with the fingers. During the massage, the fingers are run or pressed, in different orientations and at different pressures, approximately perpendicular to the surface to be massaged. In addition to a lateral movement, a vertical movement of the fingers in the direction of the surface to be massaged is necessary.

This purely manual massage work is extremely physically demanding and the advantage of the sensory monitoring of the activities is often reduced due to fatigue. For this reason, more and more mechanical tools have been developed to support the work of the physical therapist or atlas therapist.

To simulate a manual massage with a spinal massage or a spine massage device, the expert cannot use acupressure simulation devices that are used for example to acupressure sole of the foot. These acupressure simulation devices are aimed at a possibly purely point-by-point contact between the massage surfaces of the massaging body and the skin surface, as is described, inter alia, in U.S. Pat. No. 5,167,225. Specifically, the goal is to selectively massage and excite the reflex zones.

As these permanent muscle tension do not occur only directly in neck but can stretch out practically over the entire length of the spine, one has developed very early spinal massage devices, where a plurality of massaging fingers are moved to and fro in the longitudinal direction, said plurality of massaging fingers being arranged in a bed, on which lies the patient to be treated. Such a device is disclosed, for example, by the UK Patent GB 1522935-A. It discloses movable fingers of a spine massage device that has rotationally symmetrical shape and designed in particular in a conical shape. It shows massaging fingers with massage bodies in the form of a straight circular cone, which has virtually punctiform massage pressure surface. A purely linear longitudinal movement of the massaging body almost perpendicular to the skin surface can selectively massage the tissue under the skin surface with different deflection amplitudes and frequencies. Depending on the force action, the massage pressure surface can be slightly varied by differently strong impressions of the massaging body.

Even today, such devices are being still developed and commercially offered, as it shows, for example, the Korean Patent Application SK 10-2004-0098832 A.

Such elaborate massage beds are not suitable in physiotherapy practices; rather, due to their space requirements and costs, they are more often seen in clinics. Smaller devices with a certain number of massaging fingers have also been known for a long time already. An early example is the British patent GB 385711 A, in which the massaging fingers do not perform any longitudinal movement but rather a pendulum motion. A massaging device of a similar design is also known from the German Patent DE 4432184-C. Here, the individual fingers perform a combined swing and lift motion.

WO2006/027277 describes a spine massage device with a plurality of upwardly and downwardly movable massage bodies having a hemispherical contact surface. Due to the hemispherical configuration of the contact surface, the surface of the skin to be massaged can be varied within narrow limits depending on the selected deflection amplitude. Depending on the position of the massage, it is selected by the operator and it simulates a manually performed massage. This allow to achieve a reproducible variable massage pressure, which however is still used essentially point by point.

A disadvantage of the above spine massage devices is the lack of variability of the contact surface of the massaging body with the surface to be massaged. Emphasis is laid only on the longitudinal movement of the massaging body relative to the skin surface and thus only a limited possibility of movement of the plurality of massaging body can be achieved. However, it can be seen that additional different directions of movement rather mimic a manual massage and are the objective pursued by further technical development of commercially available spine massage devices.

There are also known massage devices that are provided with two massaging fingers lying on both sides of the vertebral body. A very old, a mere mechanical solution is shown, for example, in the British patent GB 333631 A. Alternatively, finally, a similarly constructed massage device is known, with two massaging fingers arranged in a housing, where however the massaging fingers themselves do not move, because a small electric motor is mounted in each of them in which an eccentric is mounted directly on the output shaft, whereby the elastically mounted finger can exert a vibration. Here, however, there is no or hardly any longitudinal movement. This solution is shown in the document WO 2008/087266 A. The two electric motors in the two fingers can be controlled independently but in dependence on the angular position. Moreover, the speed of the two motors, and thus the frequency of vibration, can be adjusted. Since the eccentric is small, a relatively high speed is required in order to produce the vibration. Therefore, in addition to a longitudinal movement, a lateral movement of the massaging body should be sought, which is disclosed, for example, in the chair-like spine massage device of U.S. Pat. No. 5,460,598. To achieve an additional massaging movement, a separate mechanism is used, which performs the lateral movement. The massaging bodies, which perform the longitudinal movement and thus simulate the pressure applied of the fingers are not designed to achieve a lateral movement and thus a full-surface massage. Separate massage rollers are guided in the lateral direction over the skin surface to be massaged by means of a separate mechanism. The massaging bodies and the massage rollers are shaped rotationally symmetrical. Even with differently selected longitudinal contact pressures, the contact area of the massaging body or the massage rollers on the skin surface varies only to a very limited extent. The massage by massage rollers and massage bodies separated and spaced therefrom clearly differs from the manual massage and generates no optimized simulation of a manual full-surface massage. While the massage rollers are rolled laterally over the surface to be massaged, at other points, a vertical localized massage is performed by the massaging bodies, wherein the contact surface of the massaging rollers is also essentially regarded as punctiform and remains substantially unchanged during the passage of the rollers over the surface to be massaged.

It is known that muscles respond to always constant vibrations in the form of a habituation effect and thus the desired resolution of the permanent muscle tension may no longer be achieved. It has also been found that a purely longitudinal lift motion of the massaging finger, as it is manually performed by a physiotherapist, achieves the best effect. The physiotherapist will anyway not perform his massage conducted by hand in an oscillation that is constant over a long period, and thus here, a habituation effect hardly exists.

On top of that, each muscle has kind of a resonance frequency. This resonant frequency is somewhat different in every muscle depending on the muscle's size, hardness, and thickness. To achieve the required relaxation effect, the physical therapist or atlas therapist must meet this frequency. However, this is not possible by hand and cannot be achieved with pure vibration devices or with devices with a constant oscillation frequency.

It is therefore the technical task of the present invention to provide a massaging device, which manages to meet the resonance frequency of the muscles to be relaxed and in which counteracts habituation.

These and other tasks are fulfilled by a massage device of the type mentioned according to the preamble of patent claim 1, which is characterized in that a frequency change of the fundamental wave is generated by means of an electronic circuit in an oscillation generated in the axial direction of the massaging finger.

In a preferred manner, the fundamental frequency is applied in a variable frequency range of 1 to 24 Hz and the frequency change takes place alternately. The frequency range between 1 and 24 Hz and the frequency of change should be alternate and not merely slowly increase or decrease. Alternating the frequency change can be effected in any rhythm. The alternating frequency change can be effected, for example, sinusoidal or also in a saw-tooth pattern. Here, the frequency change is preferably carried out in a constant rhythm with a frequency of up to 1 Hz. In contrast, optimal is a change in frequency of 0.1 to 2 Hz. It means that every 0.5 to 10 seconds, the same fundamental frequency is restored. If the frequency change itself took place with a frequency of more than 1 Hz, in principle, the muscle would in turn perceive this as a constant phenomenon and the relaxation would not occur.

In the mechanical implementation, one will obtain the frequency changes only by corresponding rhythmic changes of the rotational speed of the drive motor. Preferably a device is used that is designed mechanically as shown by the claim 5 and the dependent claims 6 to 13.

Part of the technical task is to create a massaging finger for spinal massage devices, which ensures a massage with variable size of the contact area between the massaging finger or the massaging body and the body surface to be massaged, thereby improving the simulation of a manual massage.

In particular, the inventive massaging finger should make feasible therapies according to the trigger point massage and massage according to the Dorn-Breuss method, as well the reflex zone massage as performed by the conventional dome-shaped massaging fingers. Thus, this should allow to perform both a massage based on friction and a massed based on pressure and depth action.

In the accompanying drawing, an inventive device is exemplified in its overall construction and explained in its mode of action. The figures show:

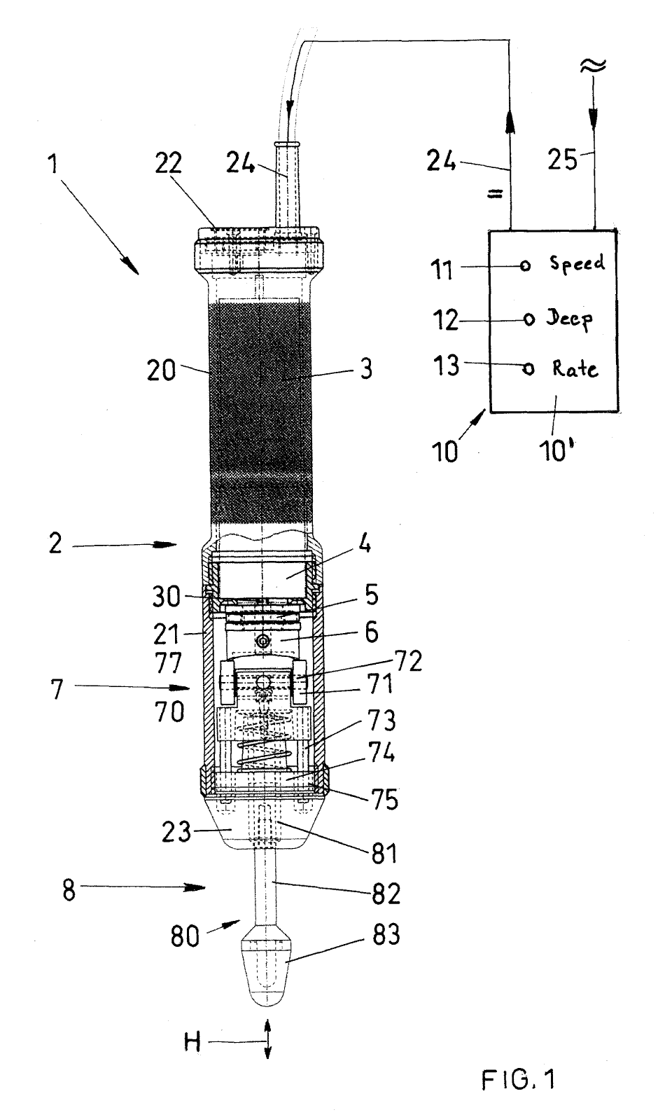

FIG. 1 shows a massage device in a longitudinal partial section, and

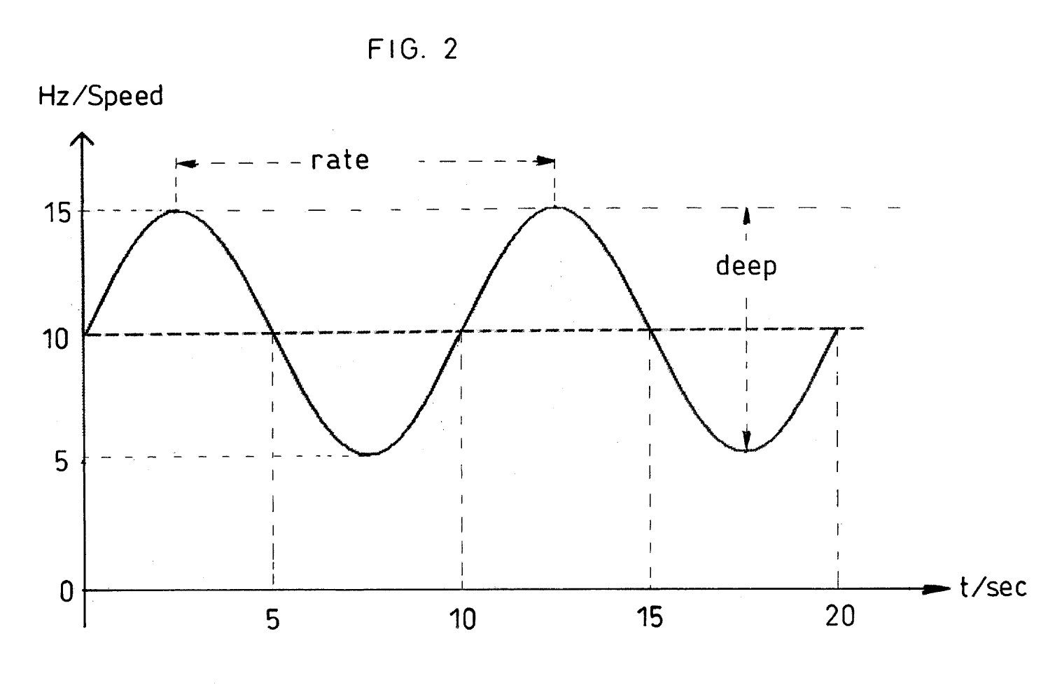

FIG. 2 shows a possible curve of the frequency change, while

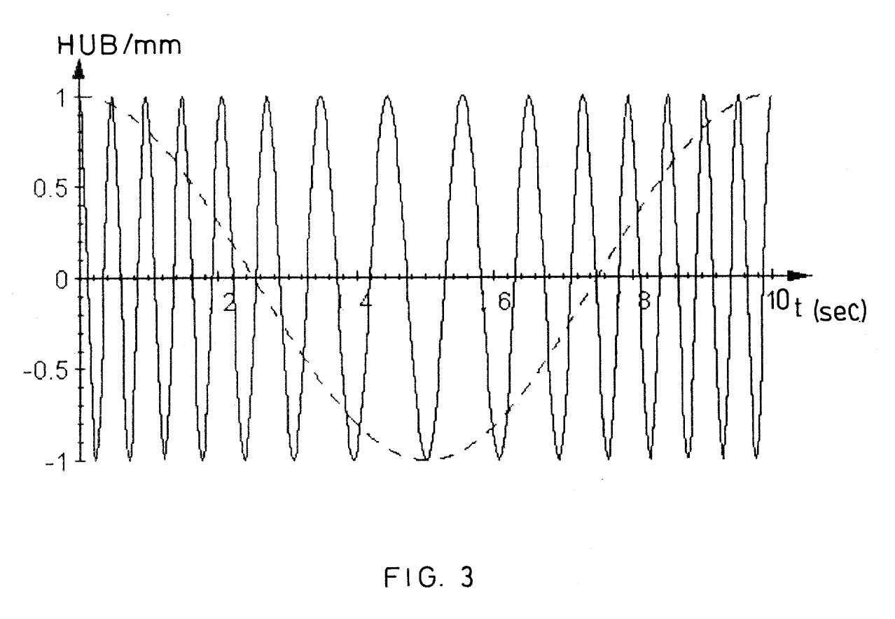

FIG. 3 represents a suitably modulated frequency

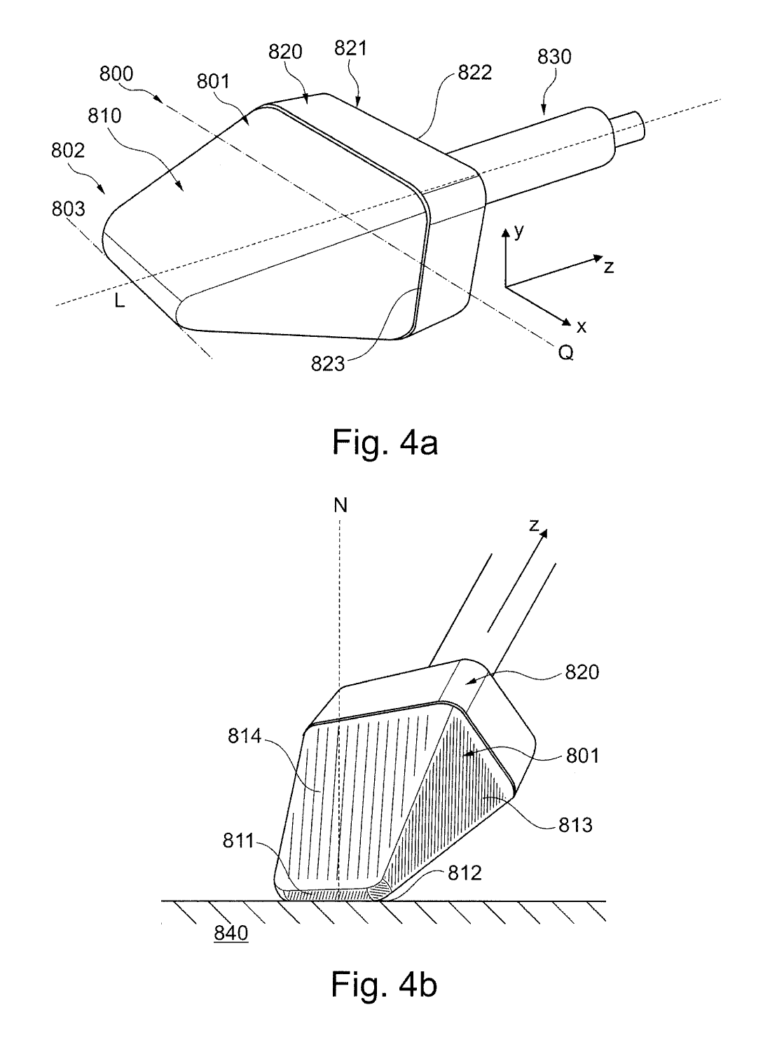

FIG. 4a shows a perspective view of a massaging finger in the supine position, while

FIG. 4b shows a perspective view of the massaging finger in contact with the

surface to be massaged

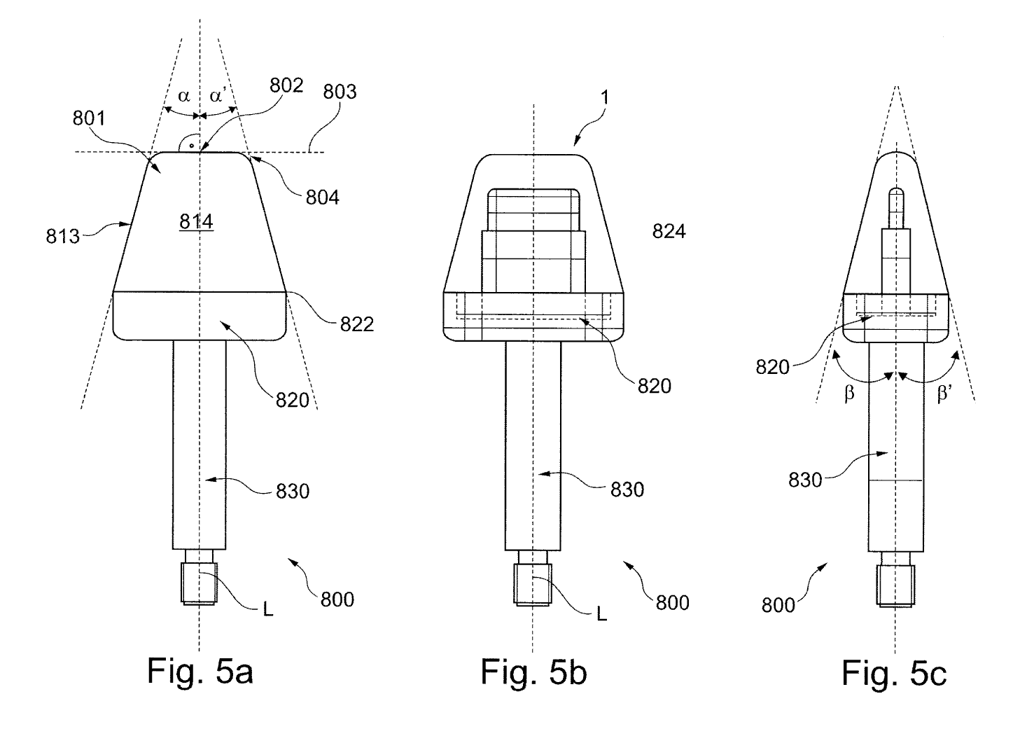

FIG. 5a shows a side view of the massaging finger according to FIG. 4, while

FIG. 5b is a partially sectioned side view, and

FIG. 5c shows a partially sectioned front view of the massaging finger according to FIG. 5a with a suggested massaging body

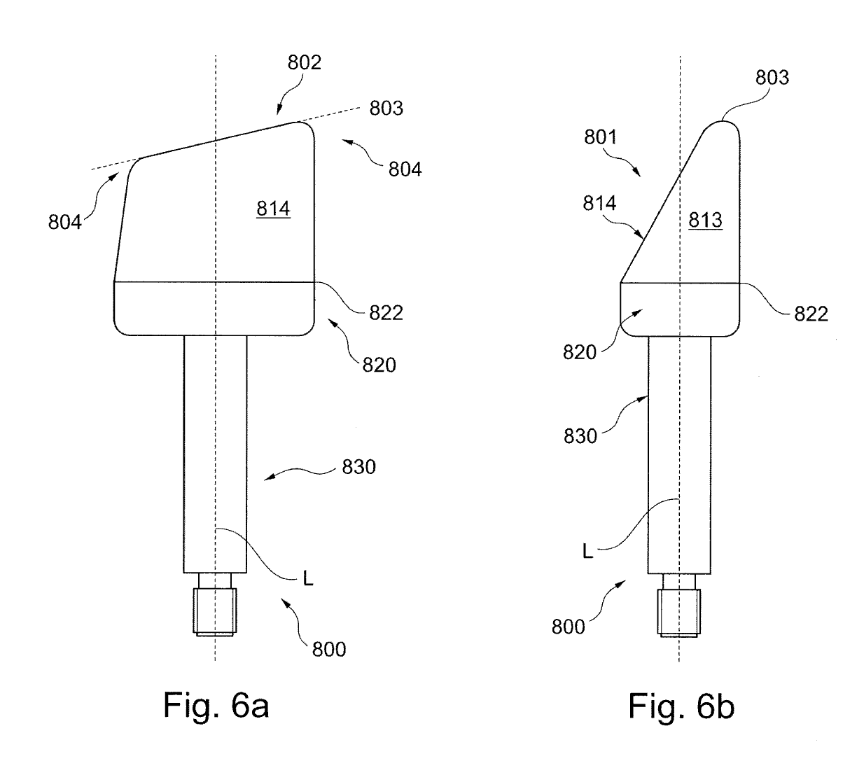

FIG. 6a shows a side view of another embodiment of a massaging finger with an asymmetrical massaging body, while

FIG. 6b shows a front view of the massaging finger according to FIG. 6a.

Prior to discussion of the actual functional features of the inventive massage device, a preferred embodiment will be described using FIG. 1. The massage device is overall designated by 1. This comprises a housing 2 and a separate controller 10, which can also be arranged in the device 1 itself, which will be discussed later. The massage device 1 comprises a housing 2, in which a motor 3 is arranged, which drives through a transmission, in this case a reduction gear, a ring-shaped sliding track 6. A guide unit 7 converts the rotary movement of the ring-shaped guide track 6 into a lift motion, which acts on a massaging finger 8. The lift motion itself is changed into an alternating lift motion by the aforementioned controller 10, which will still be described below.

The housing 2 comprises a first housing part 20, in which is mounted the motor 3 and at least a part of the reduction gear 4. In a second housing part 21 is finally arranged the guide unit 7. The first housing part 20 is closed by a cover 22, through which the supply line 24 is guided. This supply line 24 can be connected directly to the mains, or as shown here, to the controller 10, which itself has a mains connection 25. The second housing part 21 is closed by a head cover 23, through which the massaging finger 8 is passed easily movable. The two housing parts 20 and 21 can be connected to each other in a fixed or detachable connection. The housing cover 22 is typically attached to the first housing part 20 with one or more screws. The head cover 23 on the second housing part 21 can be purely frictional and/or positively attached or screwed.

An output shaft 30 acts directly on the annular guide track 6, which is mounted on a planar ball-bearing 5, which absorbs the force that is exerted on the massaging finger.

The annular guide track 6 is set in a rotating motion by the motor 3 through the reduction gear 4. This annular guide track 6 can be formed as a driven ring or a circular disc. This ring or disc has a peripheral region, which lies in the direction of the massaging finger 8 and forms the actual guide path 6. The guide track 6 preferably forms in the execution at least approximately a sinus curve. This is selected so that in each case two diametrically opposite points of the guide track 6 are at the same height. On the guide track 6 run two follower rollers ball bearings 71, preferably ball bearings that are mounted rotatably on a pivotal axis 72, in order to eliminate any free play. The follower rollers 71 or their axis 72 is connected to a guide body 70. In this guide body 70, two guide rods 73 are held. In principle, of course, more than two guide rods can be provided, which are arranged so that they are distributed uniformly over the circumference, but two guide rods 73 are quite sufficient. This guide rods 73 run through a guide plate 74. The guide plate 74 is firmly held and mounted in the end region of the second housing part 21 in the direction of the massaging finger 8. On the guide plate 74 is supported a compression spring 76, which in any position also rests against the guide body 70. In the example shown here, this compression spring is a spiral spring. Naturally, other types of compression springs, in particular also in the form of an elastomeric body may be used. To ensure stable position, the compression spring engages in a central bore in the guide body 70.

To improve the guidance of the guide rods 73 in the guide plate 74, respective sliding sleeves 75 may be appropriate. This leads to a low-friction and low-noise operation of the device 1.

Preferably, the annular guide track 6 is designed so that in each case two diametrically opposite points lie on the guide track 6 at the same height. The height difference of the two highest points and the two lowest points of the guide track 6 forms the amplitude of movement, or the stroke of the linearly moving massaging finger 8.

On the guide bodies 70, which during the roll of the follower rollers 71 on the guide track 6 perform a movement up and down, are engaged also with the massaging finger 8. This massaging finger 8 consists of a bar 80 with a terminal massage head 83. The rod 80 is preferably divided into two parts. The first rod part 81 is designed, for example, as a tube or a sleeve, while the second rod part 82 is attached to the massage head 83, is provided with a threaded pin, which can be replaceably screwed with its external thread into a corresponding internal thread in the first rod part 81. This allows to attach different, interchangeable massaging heads. In particular, for hygienic reasons one will also want to arrange both this second rod part 82 and the massaging head 83 in a detachable or replaceable design for sterilization purposes.

The FIG. 2 illustrates the process of the frequency change of the movement of the massaging finger. Since the massaging finger is moved, due to the scanning of the annular guide track, thus the change in frequency of the massaging finger is directly dependent on the rotational speed of the drive motor. In the illustrated example, this change in the rotational speed is sinusoidal. The course of a cycle is referred to as “RATE”. The mean fundamental frequency, i.e., the average number of cycles of the massaging finger, here, for example, at 10 Hz, i.e., with 10 up and down movements of the massaging finger. The result of the sinusoidal variation of the rotational speed of the drive motor is that the frequency number in the example shown here is increasing to about 15 Hz, then again decreases to the fundamental frequency of 10 Hz and then falls further to the lowest rotational speed of the drive motor, which is a frequency of 5 Hz, namely five times per second, to then increase again to the maximum of 15 Hz. The range from the lowest frequency to the highest frequency within a cycle is herein referred to as “DEEP”. In the illustrated example, the “RATE” is thus 10 seconds, that is, the cycle time is 10 seconds and the “DEEP” corresponds to a difference of 10 Hz.

Since the frequency of operation of the inventive device is between 1 and 24 Hz and the resonant frequency of the muscles is within this range, generally at about 10 to 15 Hz, the desired effect is thus always achieved.

FIG. 3 illustrates the effective vibration course of the massaging finger. The frequency change illustrated according to the FIG. 2 within a “RATE” of 10 seconds is shown here. Just like with a constant amplitude or a constant stroke, one can see that the number of oscillations per second slowly decrease and increase thereafter. Of course, this representation must be considered as merely symbolic illustration.

Furthermore, FIG. 1 shows the controller 10 is shown in a symbolically represented controller housing 10′. This controller housing 10′ has three regulating elements, which are shown here as knobs. Of course, the same could also be realized with a shift register. The top adjustment knob 11 is designed to set up the number of revolutions of the drive motor and, therefore, causes the change in the vibration frequency of the massaging finger 8 per second. The difference in the number of vibrations per second between the highest vibration frequency and the lowest vibration frequency can be adjusted with the knob 12 and is called “DEEP” accordingly. This corresponds to the setting of the modulation amplitude. And last, lowermost is still located a knob 13, by means of which the modulation frequency can be adjusted. In other words, the cycle time, which is as mentioned above, designated here as “RATE” [sic].

Of course, in the example shown here, the entire controller 10 could also be placed inside the massage device 1. The solution presented here, in which the controller is housed in a separate controller housing, is however preferable here. At the same time, in the controller housing 10′ can be housed a rectifier so that the supply voltage can be converted into a desired DC voltage, and thus the device itself can be operated with a completely harmless low voltage.

Preferably, the physical therapist or atlas therapist works with two identical devices. Just like he would normally perform such massage synchronously on both sides of the spine with his respective fingers, he will now simultaneously work with two identical devices according to the invention and, in each case, apply one device on each side of the spine. Thanks to his appropriate training and experience, he knows with what pressure he can work, when he needs to increase pressure, and if one side or the other must be worked more or less intensively depending on the concrete pattern of tension. With over 25 different settings, each need can be covered and, thanks to the constant changes in frequency, there is also no habituation effect that would counter a relaxation of muscles.

Interestingly, the device can be used both in human and in veterinary therapy.

Furthermore, a massaging finger 800 will be described in greater detail, which has a massaging body 801 and an attachment pin 830. By means of the fastening pin 830, the massaging finger 800 can be attached, in a detachable manner, to the drive of the massage device 1. By means of the drive, the massaging finger 800 is moved in a longitudinal movement in the direction of the z axis, parallel to the longitudinal axis L, perpendicular to a surface 840 to be massaged, and laterally moved over a surface 840 to be massaged in the x or y direction. By the lift motion in the z direction of the massaging finger 800, the massaging body 801 is pressed onto the surface 840 to be massaged with different pressure, and with the simultaneous lateral movement a massage effect is achieved.

The massaging body 801 is made of an elastic material, which is fastened to a base 820. The base 820 is fixed to the mounting pin 830, or is integrally formed thereon.

The surface of the massaging body 801, which can be brought into contact with the surface 840 to be massaged, is referred to herein as a contact surface 810. Due to the shape of the massaging body 801 in cooperation with the selected drive of the spine massage device, this contact surface 810 can be varied.

The massaging body 801, which is mounted in the base 820 with a base surface 821, longitudinal edges 822 and transverse edges 823, has an elongated ridge 802 on a ridge edge 803. Spaced from the base 820, this ridge 802 protrudes from the mounting pin 830. The ridge edge 803 is the cutting edge of the side surfaces 814. The surface in the space of the ridge edge 803 is referred to as the ridge surface 811, and is shown in FIG. 4b. The endings of the ridge edge 803 in the direction of the transverse axis Q of the massaging body 801 are designated as a ridge corners 804. The ridge corners 804 represent the points of intersection of the faces 813 with the ridge 802. The area in the region of the ridge corners 804 is referred to herein as a ridge corner surface 812.

If a massaging body 801 of a spatula shape as described above is moved in different angular positions of the longitudinal axis L relative to a surface normal of the surface 840 to be massaged, the side surfaces 814, the end faces 813, and the ridge corner surfaces 812 or the ridge surface 811 can form the entire contact surface 810 of the massaging body 801 with the surface 840 to be massaged.

Depending on the position of the drive, these surfaces can be brought, at least partially, in contact with the surface 840 to be massaged by a lift movement and then be moved laterally. Due to the differently shaped surfaces and different degree of the selected pressure, the contact surface 810 varies. In addition to a more selective contact on the ridge corner areas 812, a full-surface contact on one of the faces 813 or side surfaces 814 can be achieved. The dragging in a lateral plane over the surface 840 to be massaged allows an optimal simulation of a manual massage, which is also characterized by different and varied sizes of the contact areas.

Due to the elongated design of the massaging finger 800 and the plurality of massaging fingers 800 in the form of a spatula with the ridge 802, elongated contact surfaces 810 and thus elongated massage areas can be achieved.

As shown in FIG. 5a, the side surfaces 814 are arranged in a parallelogram, wherein the ridge edge 803 extends parallel to one of the longitudinal edges 822. The side surfaces 814 are formed mirror-symmetrically along the longitudinal axis L. The end surfaces 813 close with the longitudinal axis L an angle α or α′. In the embodiment of the massaging body 801 shown here, these two angles are chosen equal. Especially preferred is the selection of equally large angle α, α′ equal to 15°.

The exemplarily shown spatula-like shape of the massaging body 801 is constructed rotationally asymmetrical and has substantially triangular end faces 813, which are arranged symmetrically about the longitudinal axis L. These end faces 813 may represent, for example, equilateral or isosceles triangles, where the ridge 803 is made blunt so that a usable ridge surface 811 or ridge corner surfaces 812 usable to massage are formed. The side surfaces 814 close with the longitudinal axis L the angle β and β′. In the embodiment of the massaging body 801 shown here, these two angles are chosen equal. Particularly preferable is the choice of equally large angles β, β′ equal to 15°. Due the truncated configuration of the ridge edge 803, the ridge area 811 is enlarged.

Other symmetrically or asymmetrically executed configurations of the side faces 814 are also possible. Such massaging bodies 801 thus have trapezoidal shapes. It is also conceivable to make the massaging body 801 such that the length of the ridge edge is greater than the length of the longitudinal edges 822 and 823 or of the transverse edges of the base 803.

FIG. 6a illustrates a mirror-symmetrical execution of the side faces 814, wherein the angles α and α′ are not equal, and the ridge 803 is not formed parallel to the longitudinal edge 822. Instead of a ridge edge 803, which extends parallel to the longitudinal edge 822 or extends perpendicular to the longitudinal axis L, the ridge edge may be configured, for example, obliquely tapering from one end face 813 to the other end face 813, wherein to the relative distance between the two ridge edges 804 to the longitudinal axis L is chosen accordingly.

As shown in FIG. 6b, the end surfaces 813 are designed in the form of a right triangle, wherein the angle β, β′ are unequal. The side surfaces 814 are of different size and the ridge edge 803 is located above the longitudinal edge 822.

The base 820 shown here has a rectangular base surface 821. An optional bracket 824 is provided in the direction of the longitudinal axis L so as it protrudes into the massaging body 801 and holds and supports the elastic and deformable massaging body 801 on the base 820.

As a material for the manufacture of the massaging body 801, dimensionally stable but elastically deformable plastics are used, which after an elastic deformation by being pressed onto the body surface 840 to be massaged return back into their original shape.

Preferably, elastomers are used for the formation. For example, a material suitable for use is ethylene-propylene-diene-monomer (EPDM), which is industrially produced in the desired compositions. However, the use, for example, of natural rubber or styrene-butadiene rubber is also possible.

As experiments have shown, the Shore A hardness of the materials used in the massaging body 801 should be approximately in the range of 40 +/−15. Thus, a desired massage effect can be obtained, with the massaging body 801 sufficiently stable and robust.

The use of a suitable material can reduce the wear of the contact surface 810.

Thanks to the special design, the effective contact area can be adapted to various massage techniques by changing the inclination of the massaging finger. This allows to apply the trigger-point massage, which requires a selective pressure and a subsequent friction, a Dorn-Breuss massage, as well as the popular reflex-point massage.

### LIST OF REFERENCE NUMBER

1 Massage device
10 Controller
11 Medium rotational speed
12 Modulation amplitude (deep)
13 Modulation frequency (rate)
2 Housing
20 First housing part for engine
21 Second housing part
22 Cover
23 Head cover of the housing
24 Supply line
25 Mains connection
3 Engine
30 Drive shaft
4 Gearbox/reduction gear
5 Planar ball bearing
6 Annular sliding track
7 Guide unit
70 Guide body
71 Cam followers ball bearing
72 Axis
73 Guide rod
74 Guide plate
75 Sliding sleeves
76 Compression spring
77 Pivot pin
8 Massaging finger
80 Rod
81 First rod part as a sleeve
82 Second rod part with threaded pin
83 Massaging head
800 Massaging finger
801 Massaging body
802 Ridge
803 Ridge edge
804 Ridge corner
810 contact surface
811 Ridge surface
812 Ridge corner surface
813 Face surface
814 Side surface
820 Base
821 Base surface
822 Longitudinal edge
823 Transverse edge
824 Bracket
830 Mounting pin
840 Surface to be massaged
a Side face angle
B Face surface angle
L Longitudinal axis
Q Transverse axis
N Surface normal

1. A device for massaging or treatment of the back and neck muscles of a patient, comprising a housing having disposed therein a drive motor, which indirectly exerts an adjustable fundamental oscillation of constant amplitude onto a massaging finger, characterized in that an electronic controller, a frequency change of the fundamental oscillation can be generated, at a vibration generated in the axial direction of the massaging finger.

2. The device according to claim L characterized in that the fundamental oscillation has a variable frequency in the range of 1 to 24 Hz, and the frequency change occurs alternately, preferably in any rhythm.

3. The device according to claim 1, characterized in that the alternating frequency occurs in a constant rhythm with a frequency of up to 1 Hz, preferably between 0.1 and 2 Hz.

4. The device according to claim 1, characterized in that the frequency change occurs extending sinusoidal or in a saw-tooth pattern or by means of corresponding varying the rotation speed of the drive motor

5. The device according to claim 4, characterized in that the constant amplitude or stroke of the massaging linger is in the range between 1.0 and 0 mm.

6. The device according to claim 1, characterized in that via a transmission, the drive motor acts on a ring-shaped guide track, on which run two diametrically opposed cam followers, which run in an axis that is mounted in a guide body wherein in the guide body, at least two guide rods are held, which slide in a guide disc that is arranged fixed on the housing, through which disc also the massaging finger is directly or indirectly guided.

7. The device according to claim 6, characterized in that the annular guide track is formed as a driven ring or a circular disk, wherein the ring or the disc with its edge region, which lies in the direction of the massaging linger, forms the guide track.

8. The device according to claim 6, characterized in that the guide track in the execution forms at least approximately a sine curve.

9. The device according to claim 6. characterized in that in each case two diametrically opposite points of the slide track are on the same height.

10. The device according to claim 7, characterized in that the difference of the two highest points and the two lowest points of the guide track is equal to the amplitude of movement or the travel of the linearly moving massaging finger.

11. The device according to claim 6, characterized in that between the guide body and the guide plate is a compression spring.

12. The device according to claim 6, characterized in that the massaging finger comprises a rod that is connected with the guide body and equipped with a massaging head.

13. The device according to claim 14, characterized in that the rod is designed in two parts and the second part equipped with the head is removably connected with the first part of the rod that is attached to the guide body.

14. Use of the device according to claim 1 for massage or treatment of the back and neck muscles of a patient, characterized in that the treating person uses two devices simultaneously in order to be able to perform a massage symmetrically on both sides of the spinal, column.

15. The device according to claim 1, characterized in that it comprises a massaging body and a fastening pin for the connection of the massaging finger to said drive, wherein the massaging body has a shape different from a rotationally symmetrical form, so that depending on the relative orientation of the longitudinal axis of the massaging body to the surface to be massaged, a variable contact area can be reached, and a variable massage effect can be produced.

16. A massaging finger for a device for massage comprising a massaging body and a fastening pin for connection of the massaging finger to a drive of a spinal massage device, characterized in that the massaging body, which has a shape that deviates from the rotationally symmetrical shape so that depending on the relative orientation of the longitudinal axis of the massaging body to the surface to be massaged, a variable contact area can be reached, and a variable massage effect can be achieved.

17. The massaging finger according to claim 16, characterized in that the massaging body has a spatula shape with a ridge.

18. The massaging linger according to claim 16, characterized in that the ridge has a ridge edge that extents perpendicular to the longitudinal axis.

19. The massaging finger according to claim 16, characterized in that the ridge edge extends centrally above the base surface of the base.

20. The massaging finger according to claim 16, characterized in that the ridge edge extends parallel to a longitudinal edge of the base surface or perpendicular over one of the longitudinal edges of the base surface.

21. The massaging finger according to claim 16, characterized in that the contact surface of the massaging body is formed, at least partially, by a ridge surface and/or by a ridge corner surface and/or by a face surface and/or by a side surface.
